(19) United States
(12) Patent Application Publication
(10) Pub. No.: US 2026/0297433 A1
(43) Pub. Date: Oct. 1, 2026

(54) METHOD FOR PRODUCTION OF LOW-CARBON AVIATION FUEL THROUGH REACTIVE VISCOSITY CONTROL

(71) Applicant: Chevron U.S.A. Inc., San Ramon, CA (US)

(72) Inventors: Joel Edward SCHMIDT, Oakland, CA (US); Cong-Yan CHEN, Kensington, CA (US); Erjia GUAN, Union City, CA (US); Horacio TREVINO, Richmond, CA (US); Guan-Dao LEI, Walnut Creek, CA (US); Theodorus Ludovicus Michael MAESEN, Spring, TX (US)

(73) Assignee: Chevron U.S.A. Inc., San Ramon, CA (US)

(21) Appl. No.: 19/572,025

(22) Filed: Mar. 19, 2026

Related U.S. Application Data
(60) Provisional application No. 63/778,623, filed on Mar. 27, 2025.

(51) Int. Cl. C10G 3/00; B01J 29/74

(52) U.S. Cl. CPC C10G 3/50; B01J 29/7407; C10G 2300/1007; C10G 2300/70; C10G 2400/08

(57) ABSTRACT

Provided is a process for producing sustainable aviation fuel (SAF) from a renewable feedstock, for example fats, oils, and greases (FOG). The process comprises hydroprocessing paraffins using a Linde Type A (LTA) zeolite to selectively hydrocrack scantily branched isoparaffins. Hydroisomerization when using the present LTA catalysts greatly improves carbon efficiency because it maximizes the SAF yield and minimizes hydrogen losses to the manufacture of undesirable (lower boiling) products. By minimizing the SAF fraction that needs to be relegated to renewable diesel through selective hydrocracking of the molecules with the highest viscosity, the carbon efficiency of the reaction is greatly improved.

### CROSS REFERENCE TO RELATED APPLICATIONS

The present application claims priority to U.S. Provisional Patent Application No. 63/778,623, filed Mar. 27, 2025, the complete disclosure of which is incorporated herein by reference in their entirety.

### TECHNICAL FIELD

The present process relates to the production of sustainable aviation fuel through the hydroprocessing of sustainable feedstocks. The process employs a particular zeolite to achieve the production of sustainable aviation fluid.

### BACKGROUND

Reducing the carbon footprint of long-haul aviation presents a major challenge for the transport sector. At the current state of technology, eliminating carbon emissions through top-to-bottom electrification of the long-haul industry is unfeasible. Thus, efforts must be made to identify other possible solutions for this problem. The use of sustainable aviation fuel (SAF) represents one strategy to at least mitigate carbon emissions in the sector. SAF is an aviation fuel which can be produced from non-petroleum based renewable feedstocks. One such feedstock is fats, oils, and greases (FOG). However, the process of converting FOG feedstocks into SAF exhibits a sizable carbon footprint, hindering SAF deployment at scale.

The typical process of converting FOG into SAF involves destructively hydrogenating the FOG into a version of SAF called synthetic paraffinic kerosene (SPK). The destructive hydrogenation of FOG into SPK exhibits remarkably low carbon efficiency and SAF yield. In the typical process, large quantities of hydrogen are used to create a suitable volume of reactant product. However, the reactant product is primarily low-value product with a boiling point well below the SAF boiling range.

Hydroisomerization over hydrodewaxing catalysts improves carbon efficiency as it maximizes SAF yield and minimizes hydrogen losses to the manufacture of undesirable, lower boiling products. A drawback is that many types of FOG hydroisomerize into components that boil towards the high end of the SAF boiling range. These higher boiling components increase the viscosity of the product to a level higher than the SAF specification. The traditional solution to this problem involves relegating this higher-boiling fraction to renewable diesel through distillation, further reducing carbon efficiency and the production volume of SAF.

To provide an alternate, novel solution to enable a cleaner, more economic, efficient, and reliable production of SAF would be of great interest to the industry.

### SUMMARY

Against this backdrop the present invention was developed. In one embodiment of the claimed process, a new efficient process is provided for producing sustainable aviation fuel (SAF) when starting with a renewable feedstock. In one embodiment, the renewable feedstock comprises fats, oils, and greases (FOG). In one embodiment, the process comprises a hydroprocessing reaction. The hydroprocessing reaction, in one embodiment, is run in the presence of an LTA (Linde Type A) type zeolite catalyst. In one embodiment the LTA type zeolite of the catalyst has an acid site concentration in the range of from about 2.6 to 3.0 mol/l, and in another embodiment an acid site concentration of about 2.7 mol/l or greater. This acid site concentration has been found important. It has been found that, surprisingly, the LTA zeolite used can selectively hydrocrack paraffins to produce a high viscosity product.

Among other factors the present process is a new efficient process for producing SAF from a renewable feedstock, for example FOG. The process uses an LTA zeolite to selectively hydrocrack scantily branched isoparaffins. Hydroizomeration using LTA catalysts greatly improves carbon efficiency because it maximizes SAF yield and minimizes hydrogen losses to the manufacture of undesirable (lower boiling) products. By minimizing the SAF fraction that needs to be relegated to renewable diesel through selective hydrocracking of the molecules with the highest viscosity, the carbon efficiency of the reaction can be greatly improved.

The use of the present process offers significant economic and environmental benefits if adopted.

### DETAILED DESCRIPTION

Before the present processes for producing fuel from non-fossil feedstocks are disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Numerical values with “about” include typical experimental variances. As used herein, the term “about” means within a statistically meaningful range of a value, such as a stated particle size, concentration range, time frame, molecular weight, temperature, or pH. Such a range can be within an order of magnitude, typically within 10%, and more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, every whole number integer within the range is also contemplated as an embodiment of the invention.

The present process comprises hydroprocessing a renewable feedstock over an LTA zeolite to efficiently provide a sustainable aviation fuel (SAF) product. A sustainable aviation fuel is a fuel that meets all the same technical and safety requirements as a fossil-based jet fuel. The SAF contains the same hydrocarbons, and thus the same tailpipe emissions as fossil-based aviation fuels. The difference is that the hydrocarbons for a SAF come from a renewable, more sustainable source. For example, such a sustainable source can comprise fats, oils, and greases (FOG). This results in a net reduction of emissions when compared to fossil jet fuel on a life cycle basis.

In one embodiment the catalyst in the hydroprocessing reaction can be supported on an LTA zeolite. An LTA (Linde Type A) zeolite is a zeolite that has voids greater than about 0.50 nm in diameter, and apertures characterized by a longest diameter of less than about 0.5 nm and a shortest diameter of more than about 0.30 nm. Such LTA zeolites are described in the Atlas of Zeolite Structure Types, Fourth Revised Edition 1996.

An “aperture” in a zeolite is the narrowest passage through which an absorbing or desorbing molecule needs to pass to get into the zeolite's interior. The diameter of the aperture, dₐₚₚ (nm), is defined as the average of the shortest, dₛₕₒᵣₜ (nm), and the longest, d_{long} (nm) axis provided in the IZA (International Zeolite Association) Zeolite Atlas (http://www.iza-structure.org/databases/). Both normal-and iso-paraffins with a methyl group can pass through apertures with a d_{long}≥0.50 nm, but only normal-paraffins can pass through apertures with d_{long}<0.50 nm provided dₛₕₒᵣₜ>0.30 nm.

Apertures provide access to “voids”, the wider parts in the zeolite topology. The diameter of the void, d_{void} (nm), is characterized by the maximum diameter of a sphere that one can inflate inside such a void as per the IZA Zeolite Atlas. This characterizes, e.g., a fairly spherical LTA void (or cage) as one with a diameter of about 1.1 nm, and an elongated AFX-type void as one with a spherical diameter of about 0.78 nm. Voids are defined as cages if d_{void}/dₐₚₚ≥1.4 nm/nm. An LTA zeolite exhibits a topology with a defined combination of apertures and voids.

It is the zeolite-containing base into which the metal is loaded that is critical to the present processes. For it has been found that the present catalyst comprising a LTA zeolite in accordance herewith can provide the high conversion and minimal formation of iso-paraffins. It has been found that the key features of the catalyst zeolite include access to a pore system through apertures of a size less than 0.45 nm, and with the pore system containing voids greater than 0.50 nm in diameter. In another embodiment, the zeolite has voids greater than 0.50 nm in diameter, which are accessible through apertures characterized by a longest diameter of less than 0.5 nm and a shortest diameter of more than 0.30 nm. The LTA zeolite has such a zeolite framework. In one embodiment, the present LTA zeolite also exhibits an acid site concentration of at least about 2.7 mol/l. In one embodiment, the acid site concentration is in the range of about 2.6 mol/l to 3.0 mol/l, and in another embodiment in the range of about 2.6 mol/l to 2.8 mol/l.

LTA Zeolites are one of the most used zeolites in separations, adsorption, and ion exchange. This structure contains large spherical cages (diameter ~11.4 Å) that are connected in three dimensions by small 8-membered ring (8MR) apertures with a diameter of 4.1 Å. LTA is normally synthesized in hydroxide media in the presence of sodium with Si/Al ~1 mol/mol. By changing the cation, the limiting diameter of the 8MR apertures can be tuned, creating the highly used series of adsorbents 3A (potassium form, 2.9 Å diameter), 4A (sodium form, 3.8 Å diameter) and 5A (calcium form, 4.4 Å diameter) that are used to selectively remove species such as water, NH₃, SO₂, CO₂, H₂S, C₂H₄, C₂H₆, C₃H₆ and other n-paraffins from gases and liquids. Detergents deploy zeolite 4A because it softens water by replacing calcium and magnesium ions in “hard” water with sodium ions. While LTA zeolites are used in vast quantities for the aforementioned applications, the industry has considered the low framework Si/Al ratio and subsequent poor hydrothermal stability limits as limiting factors to succeeding under more demanding process conditions that are commonly found in catalytic applications. Yet surprisingly, the present process is found to be stable and efficient using an LTA zeolite with an acid site concentration of from about 2.6 to 3.0 mol/l.

The stability of the present LTA zeolites with 0.4 nm wide constrictions in hydroconverting n-alkanes longer than n-hexane (n-C₆) is stunning. Based on 3 months of operation without activity loss after line-out, current models indicate that a catalyst based on LTA-type zeolite would exhibit the typical run length of 2-4 years for base metal catalyst formulations and of 10-15 years for noble metal catalyst formulations at typical feeds and conditions. The catalyst sustainably hydrocracks extremely long n-paraffins, such as C₂₃⁺ in length. The stability of the hydrocracking process on the LTA-type zeolite catalyst is surprising because it is well-established that a (de)hydrogenation function needs to activate n-paraffins into n-olefins, and that these n-olefins need to enter about 11 nm wide LTA-type cages before isomerizing into iso-olefins (see J. E. Schmidt et al, ACS Catalysis vol. 13, 2023 pp 6710-6720). These iso-olefins are trapped inside the LTA-type cages, for they are too large to egress through the about 5 nm wide LTA-type windows (see P. B. Weisz, V. J. Frilette, J. Phys. Chem. vol. 64, 1960, p382). Well-established mechanisms explain how iso-olefins crack into mixtures of iso-paraffins, iso-olefins, n-paraffins and n-olefins (J. Weitkamp, P. A. Jacobs, J. A. Martens, Appl. Catal. vol. 8, 1983, pp.123-141). An iso-paraffin would require activation into an iso-olefin to enable isomerization into an n-olefin and escape from the LTA-type cage. Without a noble metal function iso-paraffins would accumulate inside the LTA-type cages, blocking access to the zeolite and deactivating the catalyst. Surprisingly, this deactivation was not observed, so that the catalyst sustainably converted longer n-paraffins into desirable linear paraffins in the C₂-C₆ carbon number range.

The discovered stability of the present LTA zeolites with about 0.4 nm wide constrictions that hydrocrack n-C₁₂⁺ and longer n-alkanes out of feed stocks containing such n-paraffins for at least three months is not intuitive. It is not intuitive because n-C₁₂⁺ and longer n-alkanes inherently hydrocrack into branched alkanes. This would imply that the primary branched alkene and alkane products would have further isomerized into n-alkenes so as to egress through 0.4 nm wide constrictors. Particularly for i-butanes (that are allegedly primary cracking products) it is not clear what mechanism would be involved to let them egress.

The discovered hydroprocessing stability of LTA zeolites with an acid concentration as high as about 2.7 mol/l is unexpected. Previously, it has been shown that the stability is inversely proportional to acid concentration, and the long-held belief in the industry is that stable operation requires an acid concentration of at most 1.8 mol/l. To improve the stability of LTA zeolites with a high acid site concentration, methods were developed to place the metals inside the zeolite to little avail. At acid concentrations higher than 1.8 mol/l, catalysts are supposed to coke up or crumble.

The stable operation of the present LTA zeolite with an acid concentration as high as 2.7 mol/l (well above the historically suggested 1.8 mol/l threshold) in the hydronormalization of n-alkanes as long as n-C₁₂⁺ remains somewhat unknown and unexpected. The present LTA zeolite having the requisite acid site concentration can continue in operation for at least 3 months and even longer, e.g., 6 months to two years or even 5 years or longer. This is counter intuitive, yet this is what has been discovered.

The catalyst for the present hydroprocessing reaction is based on the present LTA zeolite typically containing a catalytically active hydrogenation metal. The presence of a catalytically active hydrogenation metal leads to product improvement, especially IV and stability. Typical catalytically active hydrogenation metals include chromium, molybdenum, nickel, vanadium, cobalt, tungsten, zinc, platinum, and palladium. The metals platinum and palladium are especially preferred, with platinum most especially preferred. If platinum and/or palladium is used, the total amount of active hydrogenation metal is typically in the range of about 0.1 wt. % to 5 wt. % of the total catalyst, usually from about 0.1 wt. % to 2 wt. %.

The zeolite can be loaded with a hydrogenation function metal or a mixture of such metals either as is or bound with a suitable binder, such as silica, alumina, or titania. Such hydrogenating metals are known in the art and have been discussed generally earlier. The preferred metal is typically either a noble metal, such as Pd, Pt, and Au, or a base metal, such as Ni, Mo and W. A mixture of the metals and their sulfides can be used. The loading of the zeolite with the metals can be accomplished by techniques known in the art, such as impregnation or ion exchange. The hydrogenation function metal is loaded on such a selected zeolite to create the catalyst. The created catalyst can then be used in the hydroconversion process. In one embodiment, the present LTA zeolite also exhibits an acid site concentration of from about 2.6 to 3.0 mol/l, in one embodiment from about 2.6 to 2.8 mol/l, and preferably about 2.7 mol/l. This is an LTA zeolite with a higher alumina concentration than normal.

Hydroisomerization is known to be a stochastic process, resulting in the degree of branching in FOG-derived paraffin isomers to exhibit a Gaussian distribution, with a low concentration of excessively branched and a low concentration of scantily branched paraffins. Yet, surprisingly, it has been discovered that LTA-type zeolites can selectively hydrocrack scantily branched paraffins.

The selective hydrocracking of scantily branched paraffins, paraffins having few if any branches, using an LTA-type zeolite process greatly improves the carbon efficiency of the SAF production process by minimizing the quantity of the SAF fraction that needs to be relegated to renewable diesel. This selective hydrocracking occurs because only substantially linear alkenes, scantily branched paraffins, fit through the small LTA-type window. Bulky, more heavier branched alkanes are not absorbed and cannot be processed by the LTA-type zeolite of the present process. Moreover, the n-paraffin shortening retains n-paraffins.

The conditions under which the hydroconversion of the present process is carried out will generally include a temperature within a range from about 390° F. to about 800° F. (199° C. to 427° C.). In an embodiment, the temperature is in the range from about 550° F. to about 700° F. (288° C. to 371° C.). In a further embodiment, the temperature may be in the range from about 590° F. to about 675° F. (310° C. to 357° C.). The pressure may be in the range from about 50 to about 5000 psig, and typically in the range from about 100 to about 2000 psig.

The products recovered from the hydroconversion can comprise an effective amount of hydrocarbons in the SAF boiling range. This boiling range generally ranges from about 265° F. to 570° F. (130° C. to 300° C.). In one embodiment, the amount of hydrocarbons within this boiling range comprises at least 80 wt. % of the recovered product, or in one embodiment, at least 90 wt. %, or in another embodiment, at least 95 wt. %. The present process minimizes the fraction that needs to be relegated to renewable diesel, and thus provides a SAF product in good yield, effectively and efficiently.

The following example is illustrative, and is not meant to be limiting. The example provides one example of an LTA zeolite based noble metal catalyst useful in preparing an SAF.

### Example OF LTA Zeolite Based Noble Metal Catalyst

A catalyst was made by extruding 50 wt. % LTA zeolite with 50-wt-% alumina (Pural TH80 from Sasol). The KAQ-type extrudates were loaded with 0.5 wt. % Pd. The LTA zeolite used had an acid site concentration of about 2.7 mol/l.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements except for only minor traces of impurities.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

It will be clear that the compositions and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

As those skilled in the art will appreciate, numerous modifications and variations of the present invention are possible considering these teachings, and all such are contemplated hereby. For example, in addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

All of the publications cited in this disclosure are incorporated by reference herein in their entireties for all purposes.

What is claimed is:

1. A process for producing a sustainable aviation fuel from renewable feedstocks comprising:
a) providing a renewable feedstock;
b) hydroprocessing the feedstock over a Linde Type A (LTA zeolite) catalyst; and
c) recovering a hydrocarbon fraction in an aviation fuel boiling range.

2. The process of claim 1, wherein the LTA zeolite catalyst comprises a LTA zeolite that has an acid site concentration in the range of from 2.6 to 3.0 mol/l.

3. The process of claim 2, wherein the renewable feedstock is comprised of fats oils and greases (FOG) components.

4. The process of claim 1, wherein the LTA zeolite catalyst contains an active hydrogenation metal.

5. The process of claim 4, wherein the hydrogenation metal comprises a noble metal.

6. The process of claim 5, wherein the hydrogenation metal comprises palladium, platinum or gold, or a mixture thereof.

7. The process of claim 6, wherein the hydrogenation metal comprises platinum and/or palladium.

8. The process of claim 4, wherein the hydrogenation metal comprises a base metal.

9. The process of claim 8, wherein the hydrogenation metal comprises nickel, molybdenum or tungsten, or a mixture thereof.

10. The process of claim 4, wherein the amount of hydrogenation metal comprises from about 0.1 wt. % to 5 wt. % of the total catalyst.

11. The process of claim 10, wherein the amount of hydrogenation metal comprises from about 0.1 wt. % to about 2 wt. % of the total catalyst.

12. The process of claim 2, wherein the acid site concentration is in the range of from about 2.6 to 2.8 mol/l.

13. The process of claim 2, wherein the acid site concentration is about 2.7 mol/l.

14. The process of claim 1, wherein the catalyst comprises a binder.

15. The process of claim 14, wherein the binder comprises silica, alumina, or titania.

16. A process for producing a sustainable aviation fuel from a renewable feedstock comprising:
a) providing a renewable feedstock comprising fats, oils, and greases (FOG) components;
b) hydroprocessing the feedstock over a Linde Type A (LTA zeolite) catalyst where the LTA zeolite has an acid site concentration in the range of from about 2.6 to 3.0 mol/l; and
c) recovering a hydrocarbon faction comprising at least 80 wt. % hydrocarbons having a boiling point within an aviation fuel boiling range.

17. The process of claim 16, wherein the hydrocarbon fraction recovered comprises at least 90 wt. % hydrocarbon having a boiling point within the aviation fuel boiling range.

18. The process of claim 17, wherein the hydrocarbon fraction recovered comprises at least 95 wt. % of hydrocarbon having a boiling point within the aviation fuel boiling range.

19. The process of claim 16, wherein the LTA zeolite catalyst comprises a LTA zeolite that has an acid site concentration in the range of from about 2.6 to 3.0 mol/l.

20. The process of claim 19, wherein the acid site concentration is in the range of from about 2.6 to 2.8 mol/l.

21. The process of claim 19, wherein the acid site concentration is about 2.7 mol/l.

22. The process of claim 16, wherein the LTA zeolite catalyst contains an active hydrogenation metal.

23. The process of claim 22, wherein the hydrogenation metal comprises platinum and/or palladium.
